(19) United States
(12) Patent Application Publication
(10) Pub. No.: US 2023/0391652 A1
(43) Pub. Date: Dec. 7, 2023

(54) SLUDGE TREATMENT AND DEWATERING SYSTEMS

(71) Applicant: Biovac Solutions Inc., Salmon Arm (CA)

(72) Inventor: Terry SULPHUR, Salmon Arm (CA)

(21) Appl. No.: 18/032,696

(22) PCT Filed: Oct. 20, 2021
(86) PCT No.: PCT/CA2021/051477

§ 371 Date: Apr. 19, 2023

Related U.S. Application Data
(60) Provisional application No. 63/198,464, filed on Oct. 20, 2020.

(51) Int. Cl. C02F 11/147

(52) U.S. Cl. CPC C02F 11/147; C02F 2201/005

(57) ABSTRACT

An apparatus for dewatering sludge comprising: a tank having an internal space divided by a dividing wall into an intake chamber and an extract chamber; an intake pipe connected to the intake chamber and comprising an intake valve for selectively opening and closing the intake pipe; a discharge pipe connected to the extract chamber and comprising a discharge valve for selectively opening and closing the discharge pipe; a transfer pipe providing fluid communication between a bottom portion of the intake chamber and a top portion of the extract chamber, the transfer pipe extending upwardly out of the tank from the intake chamber and downwardly into the tank into the extract chamber and comprising a transfer valve external to the tank for selectively opening and closing the transfer pipe; a pump for selectively creating positive and negative pressure within the intake chamber; and, a screen within the extract chamber positioned between the second opening of the transfer pipe and the discharge pipe.

### CROSS-REFERENCE TO RELATED APPLICATIONS

This application claims the benefit of priority of U.S. Provisional Patent Application No. 63/198,464 filed Oct. 20, 2020, which is hereby incorporated herein by reference in its entirety.

### TECHNICAL FIELD

The present disclosure relates to sewage sludge treatment. Particular embodiments relate to systems, apparatus and methods for dewatering sludge and other materials.

### BACKGROUND

Sewage sludge is composed of a mixture of solid and liquid. Separating the liquid from the solid allows the liquid to be reused and the solid to be transported more efficiently for treatment. Various systems for separating liquids from sludge or other materials exist in the prior art, including: U.S. Pat. No. 3,677,409, U.S. Pat. No. 5,503,753, U.S. Pat. No. 4,816,167, U.S. Pat. No. 3,028,011, US 2016/0289109, U.S. Pat. No. 5,462,661, U.S. Pat. No. 4,021,347, and WO 2018/232517.

The inventor has determined a need for improved systems, apparatus, and methods for dewatering sludge and other materials.

### SUMMARY

One aspect provides an apparatus for dewatering sludge comprising: a tank having an internal space divided by a dividing wall into an intake chamber and an extract chamber; an intake pipe connected to the intake chamber and comprising an intake valve for selectively opening and closing the intake pipe; a discharge pipe connected to the extract chamber and comprising a discharge valve for selectively opening and closing the discharge pipe; a transfer pipe providing fluid communication between a bottom portion of the intake chamber and a top portion of the extract chamber, the transfer pipe extending upwardly out of the tank from the intake chamber and downwardly into the tank into the extract chamber and comprising a transfer valve external to the tank for selectively opening and closing the transfer pipe; a pump for selectively creating positive and negative pressure within the intake chamber; and, a screen within the extract chamber positioned between the second opening of the transfer pipe and the discharge pipe.

Further aspects of the present disclosure and details of example embodiments are set forth below.

### DRAWINGS

The following figures set forth embodiments in which like reference numerals denote like parts. Embodiments are illustrated by way of example and not by way of limitation in the accompanying figures.

FIG. 1 schematically illustrates an example dewatering system according to one embodiment of the present disclosure.

FIG. 1A schematically illustrates an example dewatering system according to another embodiment of the present disclosure.

FIG. 2 shows an upper exterior portion of the tank and the transfer pipe of a prototype dewatering system according to one embodiment of the present disclosure.

FIG. 3 is a sketch of an example sludge pressure relief valve according to one embodiment of the present disclosure.

FIG. 4 shows details of a polymer injection subsystem of a prototype dewatering system according to one embodiment of the present disclosure.

### DETAILED DESCRIPTION

The following describes example sludge dewatering systems, and related apparatus and methods.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

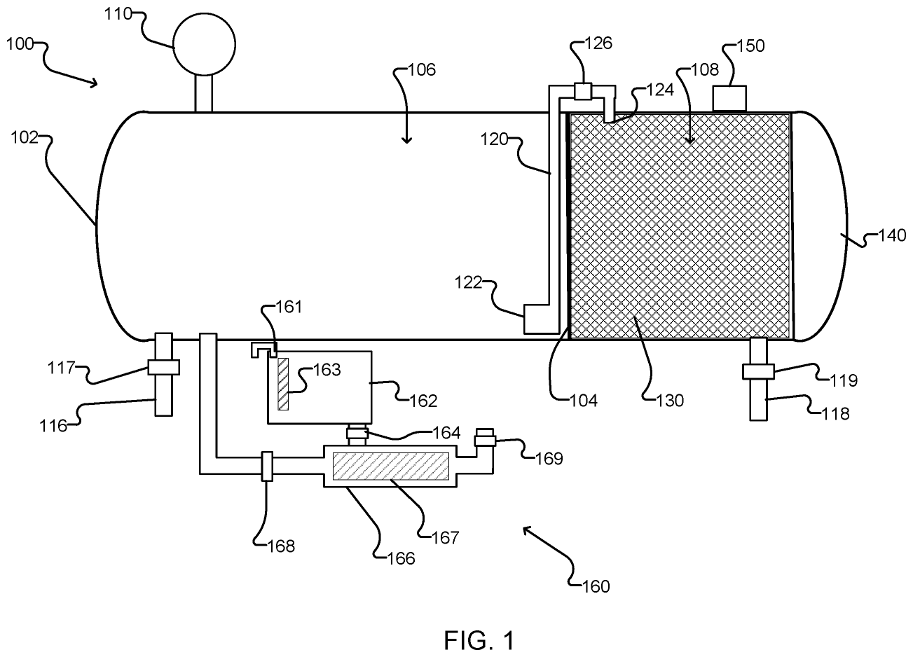

FIG. 1 schematically illustrates an example an example dewatering system 100 according to one embodiment of the present disclosure. The system 100 comprises a tank 102 having an internal space divided by a dividing wall 104 into an intake chamber 106 and an extract chamber 108. A pump 110 is connected to the intake chamber 106 to selectively create positive and negative pressure in the intake chamber 106. The pump 110 may have one or more filters (e.g. a primary filter and a secondary filter) in some embodiments. In some embodiments, the pump 110 and filters may be substantially the same as those in standard vacuum trucks. In some embodiments, the system 100 is mounted on a truck or trailer, as described for example in International Publication No. WO 2018/232517, which is hereby incorporated by reference herein.

An intake pipe 116 having an intake valve 117 is connected to the intake chamber 106 for drawing sludge or other materials into the tank as discussed below. A coarse intake filter (not shown), such as for example a canister filter, may be provided on the intake pipe to prevent large (e.g. greater than about ½inch diameter) solids from entering the intake chamber 106. A discharge pipe 118 having a discharge valve 119 is connected to the extract chamber 108 for discharge of liquids from the tank as discussed below.

In some embodiments, the system may also comprise a mixing subsystem for mixing sludge in the intake chamber 106. The mixing subsystem may, for example, comprise a bubble mixer, such as a Large Bubble Mixer of the type available from Pulsair Systems Inc. FIG. 1A shows an example embodiment of a system 100A that includes a mixing subsystem 170 comprising a source of compressed gas 172 (e.g. air) connected by one or more hoses to one or more accumulator plates 174 on the bottom of the intake chamber 106. In some embodiments, the pump 110 may act as the source of compressed gas 172. In some embodiments, where the system 100 is mounted on a truck the source of compressed gas 172 comprises the compressor on the truck. In other embodiments, the system may include a different type of mixing subsystem, such as other pneumatic mixers, mechanical mixers, or other mixing means, or may not include a mixing subsystem.

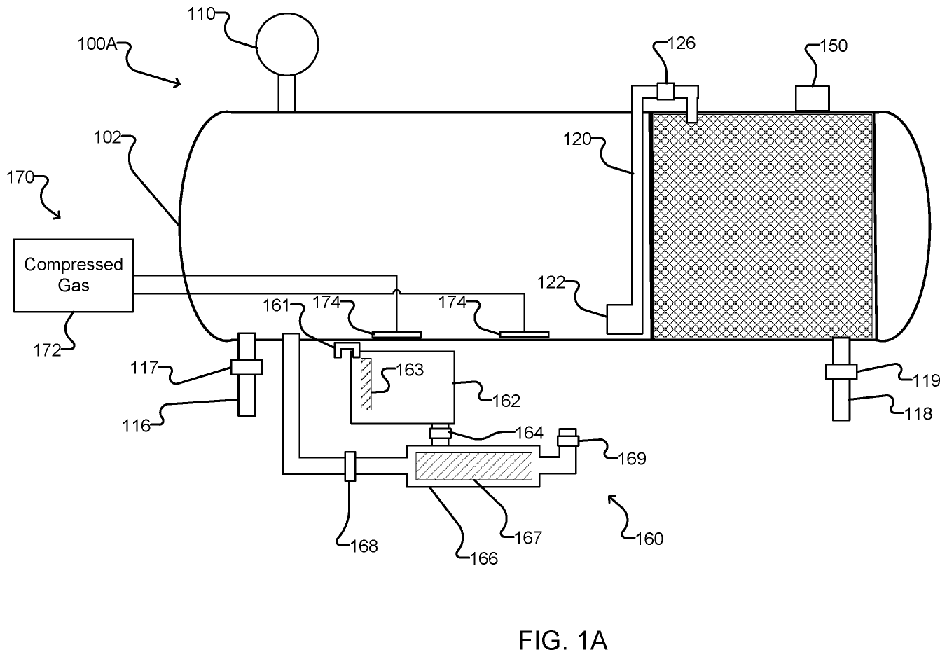

A transfer pipe 120 provides fluid communication between the intake chamber 106 and the extract chamber 108. The transfer pipe 120 has a first opening 122 near the bottom of the intake chamber 106 and a second opening 124 near the top of the extract chamber 108. The transfer pipe 120 has a transfer valve 126 therein for selectively sealing off the extract chamber 108 from the intake chamber 106. The transfer pipe 120 extends upwardly out of the tank 102 from the top of the intake chamber 106, across the top of the dividing wall 104, and back down into the extract chamber 108, with the transfer valve 126 located in the portion of the transfer pipe 120 that is external to the tank 102. In some embodiments, the transfer valve 126 comprises a hydraulic valve, as shown for example in FIG. 2, wherein the transfer valve 126 is controlled by means of hydraulic control conduits 127.

A screen 130 is positioned within the extract chamber 108 between the second opening 124 of the transfer pipe 120 and the opening of the discharge pipe 1 18. In some embodiments, the screen 130 may substantially conform to the shape of the extract chamber 108 and may have a hole for the second opening 124 of the transfer pipe 120. In the illustrated example, the end portion of the extract chamber 108 of the tank 102 comprises a door 140, which may be opened to permit access to the extract chamber 108 for removal of solids. In some embodiments, the screen 130 comprises an open end with a generally circular rim, which presses up against a rim of the door 140 when the screen 130 is in place and the door 140 is closed. The door 140 may be held closed by a latch or any other suitable mechanism. The intake chamber 106 of the tank 102 may also be provided with a relief valve, pressure gauge, and one or more access hatches or cleaning ports (not shown). In some embodiments, the tank 102 may have other combinations of features as disclosed in International Publication No. WO 2018/232517, which is hereby incorporated by reference herein.

In some embodiments, the dewatering apparatus 100 may be installed on a truck bed, on a trailer or any other transport platform to move the apparatus to and from worksites. To commence sludge intake, the intake pipe 116 is connected to a hose or the like (not shown) that is placed into a source of sludge. Negative pressure is applied to the intake chamber 106 by the pump 110, with the intake valve 117 open, causing the sludge to be drawn into the intake chamber 106 through the intake pipe 116. A polymer is injected into the intake chamber 106 to cause solids in the sludge to coagulate into clumps. In the example illustrated in FIG. 1, polymer is injected by a polymer injection subsystem 160. Details of an example polymer injection subsystem are discussed further below.

Once the sludge is in the intake chamber 106, the intake valve 117 is closed and positive pressure is applied to the intake chamber 106 by the pump 110, with the discharge valve 119 open. This positive pressure causes the sludge to be forced into the first opening 122, up the transfer pipe 120, and through the second opening 124 into the extract chamber 108. After the sludge passes through the second opening 124 into the extract chamber 108 the screen 130 separates the solid and liquid by blocking the solid and permitting the liquid to pass through the screen 130 and out through the discharge pipe 118.

In some embodiments, once liquid has been discharged, the door 140 is opened and the solids caught by the screen 130 within the extract chamber 108 are manually removed by shoveling or other means. In some embodiments, the tank 102 may be tipped for dumping, for example by raising a truck bed on an incline.

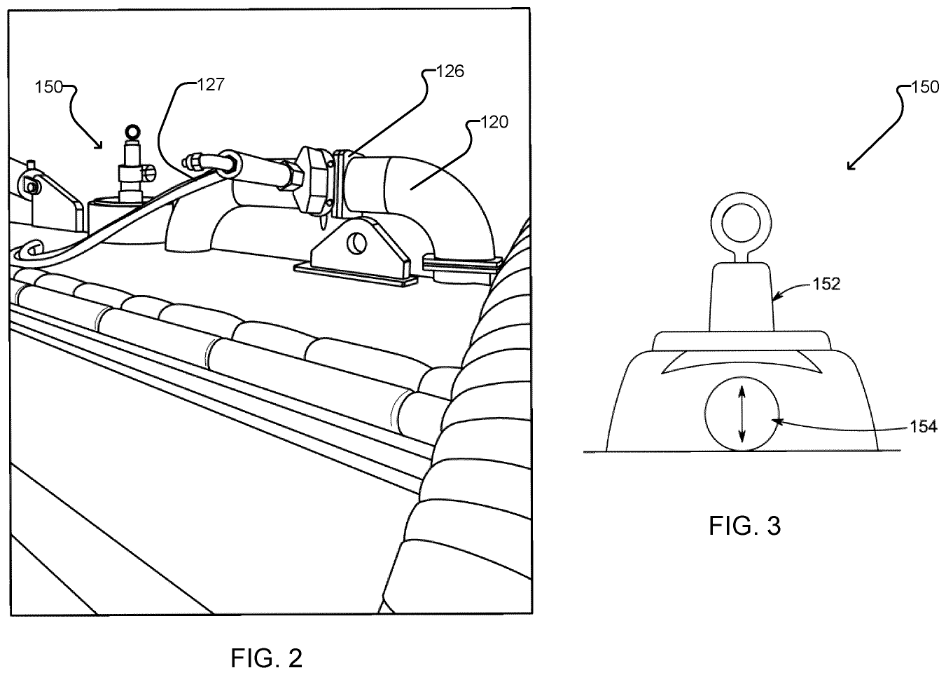

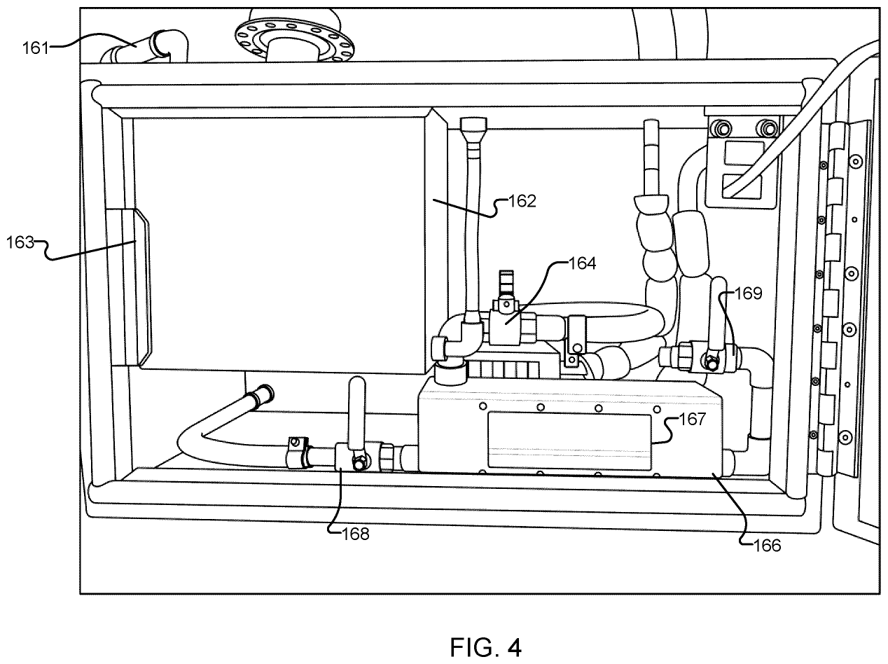

In the example illustrated in FIG. 1, the tank 102 also comprises a sludge pressure relief valve 150 in an upper portion of the extract chamber 108. The pressure relief valve allows air and other gasses to escape the extract chamber 108 if the pressure therein exceeds a predetermined threshold. The sludge pressure relief valve 150 also comprises a ball float shut off for preventing liquid from being discharged therethrough. FIG. 3 shows an example sludge pressure relief valve 150 according to one embodiment. Valve 150 comprises an air pressure release valve 152 in an upper portion thereof, with a ball float shut off 154 below such that as the level of liquid within the extract chamber rises the ball will float on the liquid and block access to the pressure release valve 152 to prevent discharge of liquid. In some embodiments, the system 100 may also include one or more sensors connected to one or more processing elements configured to trigger an alarm to let an operator know to discharge liquid.

In the example illustrated in FIG. 1, polymer is injected into the intake chamber 106 of the tank 102 by a polymer injection subsystem 160 comprising a holding tank 162 connected to an injection chamber 166 through a fill valve 164. The holding tank 162 has a vent 161 for allowing air into the holding tank 162 as polymer is withdrawn into the injection chamber 166. The holding tank 162 also has a sight tube 163 allowing an operator to see the amount of polymer remaining in the holding tank 162. The injection chamber 166 has a sight glass 167 allowing an operator to see how much polymer is in the injection chamber 166. The injection chamber is connected to the intake chamber 106 of the tank 102 through a polymer injection valve 168, and has a vent with a vent valve 169. In operation, an operator opens the fill valve 164 to allow a desired amount of polymer to flow from the holding tank 162 into the injection chamber 166, then closes the fill valve 164 and opens the polymer injection and vent valves 168 and 169, with the pump 110 applying negative pressure to the intake chamber 106, in order to draw the polymer into the intake chamber 106.

The embodiments of the systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface. For example, the programmable computers may be a server, network appliance, connected or autonomous vehicle, set-top box, embedded device, computer expansion module, personal computer, laptop, personal data assistant, cloud computing system or mobile device. A cloud computing system is operable to deliver computing service through shared resources, software and data over a network. Program code is applied to input data to perform the functions described herein and to generate output information. The output information is applied to one or more output devices to generate a discernible effect. In some embodiments, the communication interface may be a network communication interface. In embodiments in which elements are combined, the communication interface may be a software communication interface, such as those for inter-process communication. In still other embodiments, there may be a combination of communication interfaces.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. In any case, the language may be a compiled or interpreted language. Each such computer program may be stored on a storage media or a device (e.g. ROM or magnetic diskette), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

Embodiments described herein may relate to various types of computing applications, such as image processing and generation applications, computing resource related applications, speech recognition applications, video processing applications, semiconductor fabrication, and so on. By way of illustrative example embodiments may be described herein in relation to image-related applications.

Throughout the foregoing discussion, numerous references may be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments of the present disclosure may be in the form of a software product. The software product may be stored in a non-volatile or non- transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various example embodiments described herein.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As will be apparent to those skilled in the art in light of the foregoing disclosure, many alterations and modifications are possible to the methods and systems described herein. While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as may reasonably be inferred by one skilled in the art. The scope of the claims should not be limited by the embodiments set forth in the examples, but should be given the broadest interpretation consistent with the foregoing disclosure.

The present disclosure may be embodied in other specific forms without departing from its spirit or essential characteristics. The described embodiments are to be considered in all respects only as illustrative and not restrictive.

1. An apparatus for dewatering sludge comprising:
a tank having an internal space divided by a dividing wall into an intake chamber and an extract chamber;
an intake pipe connected to the intake chamber and comprising an intake valve for selectively opening and closing the intake pipe;
a discharge pipe connected to the extract chamber and comprising a discharge valve for selectively opening and closing the discharge pipe;
a transfer pipe providing fluid communication between a bottom portion of the intake chamber and a top portion of the extract chamber, the transfer pipe extending upwardly out of the tank from the intake chamber and downwardly into the tank into the extract chamber and comprising a transfer valve external to the tank for selectively opening and closing the transfer pipe;
a pump for selectively creating positive and negative pressure within the intake chamber;
a screen within the extract chamber positioned between the second opening of the transfer pipe and the discharge pipe.

2. The apparatus of claim 1 comprising a mixing subsystem for mixing contents of the intake chamber.

3. The apparatus of claim 2 wherein the mixing subsystem comprises a source of compressed gas connected to one or more accumulator plates positioned in a bottom portion of the intake chamber.

4. The apparatus of claim 1 comprising a polymer injection subsystem for adding polymer to the intake chamber.

5. The apparatus of claim 4 wherein the polymer injection subsystem comprises a holding tank connected to an injection chamber through a fill valve, wherein the injection chamber is connected to the intake chamber though a polymer injection valve.

6. The apparatus of claim 5 wherein the holding tank comprises a vent for allowing air into the holding tank as polymer is withdrawn from the holding tank into the injection chamber.

7. The apparatus of claim 5, wherein the holding tank comprises a sight tube configured to allow visual inspection of a level of polymer remaining in the holding tank.

8. The apparatus of claim 5 wherein the injection chamber comprises a sight glass configured to allow visual inspection of polymer is in the injection chamber. .

9. The apparatus of claim 5 wherein the injection chamber comprises an injection chamber vent with an injection chamber vent valve for allowing air into the injection chamber as polymer is withdrawn from the injection chamber into the intake tank.

10. The apparatus of claim 1 comprising a pressure relief valve in an upper portion of the extract chamber, wherein the pressure relief valve comprises a ball float shut off for preventing liquid from being discharged though the pressure relief valve.

11. An apparatus for dewatering sludge comprising:
a tank having an internal space divided by a dividing wall into an intake chamber and an extract chamber;
an intake pipe connected to the intake chamber and comprising an intake valve for selectively opening and closing the intake pipe;
a discharge pipe connected to the extract chamber and comprising a discharge valve for selectively opening and closing the discharge pipe;
a transfer pipe providing fluid communication between a bottom portion of the intake chamber and a top portion of the extract chamber, the transfer pipe extending upwardly out of the tank from the intake chamber and downwardly into the tank into the extract chamber and comprising a transfer valve external to the tank for selectively opening and closing the transfer pipe;
a pump for selectively creating positive and negative pressure within the intake chamber;
a screen within the extract chamber positioned between the second opening of the transfer pipe and the discharge pipe;
a polymer injection subsystem for adding polymer to the intake chamber;
a mixing subsystem for mixing contents of the intake chamber; and, a pressure relief valve in an upper portion of the extract chamber configured to allow air and other gasses to escape the extract chamber when a pressure in the extract chamber exceeds a predetermined threshold, wherein the pressure relief valve comprises a ball float shut off for preventing liquid from being discharged therethrough.

12. The apparatus of claim 11 wherein the polymer injection subsystem comprises a holding tank connected to an injection chamber through a fill valve, wherein the injection chamber is connected to the intake chamber though a polymer injection valve.

13. The apparatus of claim 12 wherein holding tank comprises a sight tube configured to allow visual inspection of a level of polymer remaining in the holding tank, and wherein the injection chamber comprises a sight glass configured to allow visual inspection of polymer is in the injection chamber.

14. The apparatus of claim 12 wherein the injection chamber comprises an injection chamber vent with an injection chamber vent valve for allowing air into the injection chamber as polymer is withdrawn from the injection chamber into the intake tank.

15. The apparatus of claim 12 wherein the mixing subsystem comprises one or more accumulator plates positioned in a bottom portion of the intake chamber connected to receive compressed gas and configured to release bubbles of gas upwardly through the intake chamber.

16. The apparatus of claim 13 wherein the injection chamber comprises an injection chamber vent with an injection chamber vent valve for allowing air into the injection chamber as polymer is withdrawn from the injection chamber into the intake tank.

17. The apparatus of claim 16 wherein the mixing subsystem comprises one or more accumulator plates positioned in a bottom portion of the intake chamber connected to receive compressed gas and configured to release bubbles of gas upwardly through the intake chamber.
